(19) United States
(12) Patent Application Publication
(10) Pub. No.: US 2008/0138763 A1
(43) Pub. Date: Jun. 12, 2008

(54) Sleeve for dental articulator and method of using the same

(76) Inventor: Mark S. Fernandez, North Tonawanda, NY (US)

Correspondence Address: SIMPSON & SIMPSON, PLLC, 5555 MAIN STREET, WILLIAMSVILLE, NY, 14221-5406, US

(21) Appl. No.: 11/635,351

(22) Filed: Dec. 7, 2006

(51) Int. Cl. A61C 11/08; A61C 11/00

(52) U.S. Cl. 433/54; 433/60

(57) ABSTRACT

The present invention broadly comprises a sleeve for a dental articulator having upper and lower jaws operatively arranged to simulate a human mouth, the sleeve including an enclosure having a mounting surface and at least one open end, the enclosure arranged to substantially cover and releasably engage the upper or lower jaw of the dental articulator. The sleeve may further include a releasable locking means operatively arranged to releasably secure the sleeve to the upper or lower jaw of the dental articulator. The present invention also broadly comprises a method of mounting a dental model on a dental articulator having upper and lower jaws arranged to simulate a human mouth, the method including the steps of releasably securing a sleeve on the upper or lower jaw of the dental articulator and fixedly securing the dental model to the sleeve. The method may further include the step of removing the sleeve from the upper or lower jaw of the dental articulator.

### FIELD OF THE INVENTION

The invention broadly relates to dental articulators, more specifically to means for mounting dental models on dental articulators, and even more particularly to a releasably securable means for mounting dental models on dental articulators.

### BACKGROUND OF THE INVENTION

FIG. 1 is a perspective view of prior art dental articulator 10 having dental model 12 fixedly secured thereto. This type of articulator, as well as variations on this type, are common mechanical devices used to represent the temporomandibular joint and jaws. Hinge 14, which represents the temporomandibular joint, simulates jaw movements. Maxillary dental cast 16 is attached to upper jaw 20, while mandibular dental cast 18 is attached to lower jaw 22. Dental articulator 10 is used for the mounting of dental casts for diagnosis, treatment planning, and patient presentation, used for fabrication of occlusal surfaces for dental restorations, and used for the arrangement of teeth for complete and partial dentures. Articulator 10 is often constructed from a metal material and is not considered a disposable commodity. Therefore, after a dentist or technician finishes their work with the dental casts, maxillary and mandibular dental casts 16 and 18, respectively, are removed from articulator 10 so that new dental casts may be fixedly secured thereto.

FIG. 2 is a perspective view of prior art dental articulator 10 after removal of a fixedly secured dental model and remaining bonding agent (not shown). As can be seen in FIG. 2, at times, removal of maxillary and mandibular dental casts 16 and 18, respectively, and any remaining bonding agent often causes damage to one or both of upper and lower jaws 20 and 22, respectively. Upper and lower mounts 24 and 26, respectively, can break due to the force required to remove the bonding material, e.g., plaster, which fixedly secured dental casts 16 and 18 to mounts 24 and 26, respectively. Thus, during dental cast removal, mounts 24 and 26 may be broken as shown in FIG. 2, i.e., holes 28 and 30 in mounts 24 and 26, respectively.

Thus, there is a long-felt need for a means of releasably securing a dental cast and/or model to an articulator. There is a further long-felt need for a dental articulator that includes means for releasably securing a dental cast and/or model to an articulator. This is also a long-felt need for a method of releasably securing a dental cast and/or model to a dental articulator.

### BRIEF SUMMARY OF THE INVENTION

The present invention broadly comprises a sleeve for a dental articulator having upper and lower jaws operatively arranged to simulate a human mouth, the sleeve including an enclosure having a mounting surface and at least one open end, the enclosure arranged to substantially cover and releasably engage the upper or lower jaw of the dental articulator. In an embodiment, the sleeve for a dental articulator may further include a releasable locking means operatively arranged to releasably secure the sleeve to the upper or lower jaw of the dental articulator. In one embodiment, the releasable locking means is a tab, while in another embodiment, the releasable locking means is a clip and in yet another embodiment, the releasable locking means is a hook.

In a further embodiment, the enclosure includes a textured surface. The textured surface may be operatively arranged to provide additional surface area for bonding a dental model thereto with an adhesive, or the textured surface may include a plurality of elevations extending outwardly from the enclosure.

The enclosure, in yet another embodiment, is a longitudinal enclosure adapted for the dental articulator having a closed first end and an open second end opposite the closed first end. The enclosure may include an alignment pin retaining means disposed proximate the closed first end, and the alignment pin retaining means may be integral to the closed first end or may be releasably secured to the closed first end. In a further embodiment, the enclosure may be a longitudinal enclosure adapted for the dental articulator having an open first end and an open second end opposite the open first end. The enclosure may be constructed from a material selected from the group consisting of wood, metal, plastic, ceramic and combinations thereof.

The present invention also broadly comprises a dental articulator having upper and lower jaws arranged to simulate a human mouth and a sleeve having a mounting surface and at least one open end, the sleeve arranged to substantially cover and releasably engage the upper or lower jaw of the dental articulator.

Another embodiment of the present invention comprises a dental articulator having upper and lower jaws arranged to simulate a human mouth and a first sleeve having a mounting surface and at least one open end, the first sleeve arranged to substantially cover and fixedly secure to the upper or lower jaw of the dental articulator. This embodiment may further include a second sleeve operatively arranged to substantially cover and releasably engage the first sleeve.

Yet another embodiment of the present invention comprises a method of mounting a dental model on a dental articulator having upper and lower jaws arranged to simulate a human mouth, the method includes the steps of: (a) releasably securing a sleeve on the upper or lower jaw of the dental articulator; and, (b) fixedly securing the dental model to the sleeve. The method may further include the step of: (c) removing the sleeve from the upper or lower jaw of the dental articulator.

It is a general object of the present invention to provide a convenient means to releasably secure a dental model to a dental articulator.

It is another general object of the present invention to prolong the useful life of a dental articulator by preventing structural damage during removal of a dental model therefrom.

It is yet another object of the present invention to provide a means to adapt a dental articulator for a plurality of methods of use.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a prior art dental articulator having a dental model fixedly secured thereto;

FIG. 2 is a perspective view of a prior art dental articulator after removal of a fixedly secured dental model and remaining bonding agent;

FIG. 3 is a perspective view of two embodiments of present invention sleeves releasably secured to a dental articulator;

FIG. 4 is a perspective view of two embodiments of present invention sleeves being removed from a dental articulator;

FIG. 5 is a perspective view of a dental articulator after removal of the present invention sleeves shown in FIG. 4;

FIG. 6 is a perspective view of two embodiments of present invention sleeves releasably secured to a dental articulator and each having dental models fixedly secured thereon;

FIG. 7 is a perspective view of an embodiment of a present invention sleeve for a dental articulator;

FIG. 8 is a perspective view of another embodiment of a present invention sleeve for a dental articulator;

FIG. 9 is a perspective view of yet another embodiment of a present invention sleeve for a dental articulator;

FIG. 10 is a perspective view of an embodiment of a present invention sleeve having a dental model fixedly secured thereto;

FIG. 11 is a cross-sectional view of an embodiment of a present invention sleeve taken generally along line 11-11 of FIG. 3;

FIG. 12 is a perspective view of a further embodiment of a present invention sleeve for a dental articulator having an alignment pin and a textured surface;

FIG. 13 is a side elevational view of the embodiment of the present invention sleeve of FIG. 12 shown installed on a dental articulator;

FIG. 14 is a perspective view of another embodiment of a present invention sleeve for a dental articulator having two open ends; and,

FIG. 15 is a perspective view of yet another embodiment of present invention sleeves fixedly secured to a dental articulator and having removable sleeves disposed thereon.

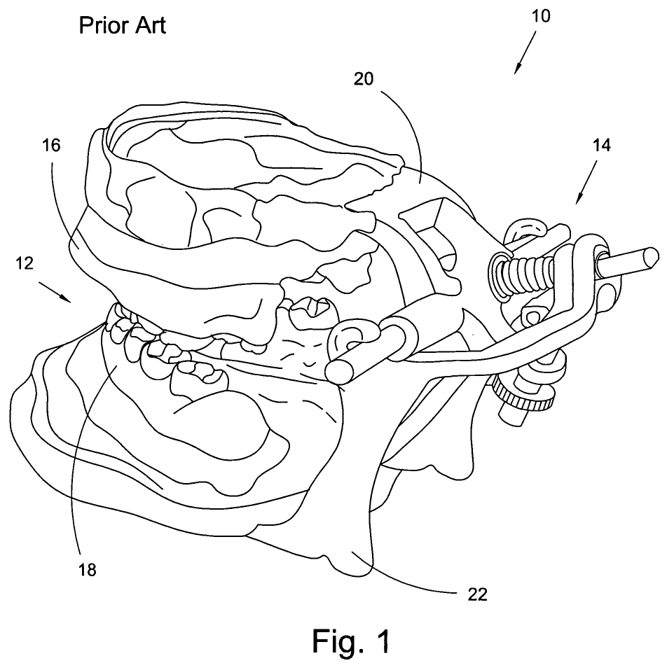

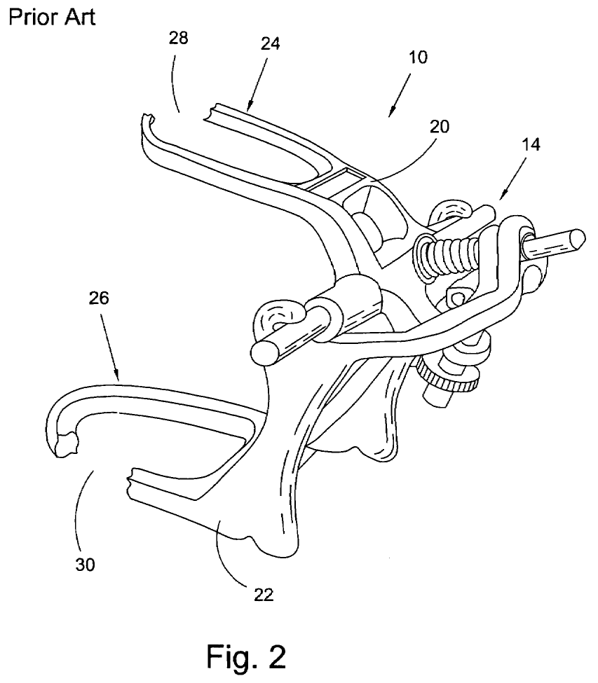

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “sleeve” is synonymous with terms such as “enclosure”, “fingerless mitt”, “cot”, “pouch”, “cover sheath”, “protective covering”, etc., and such terms may be used interchangeably as appearing in the specification and claims. Although any methods, devices or materials similar or equivalent to those described herein can be used in the practice or testing of the invention, the preferred methods, devices, and materials are now described.

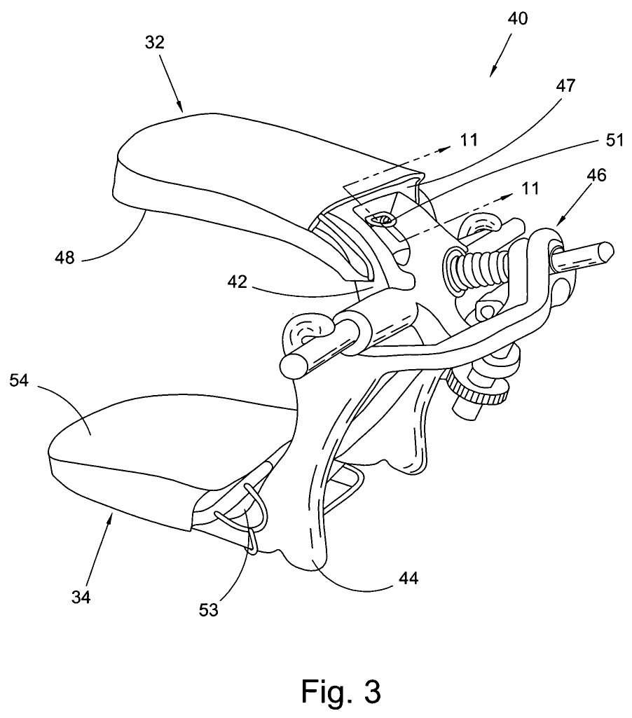

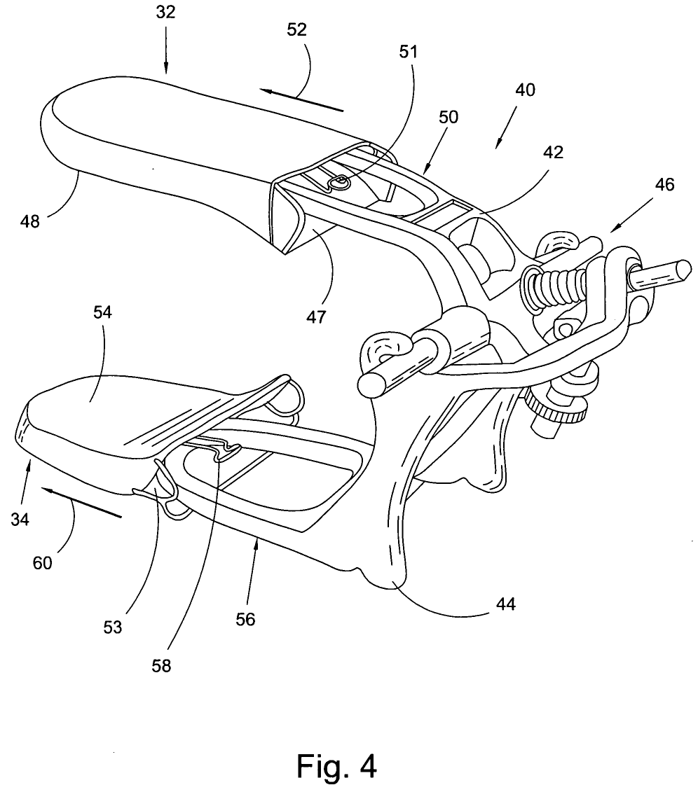

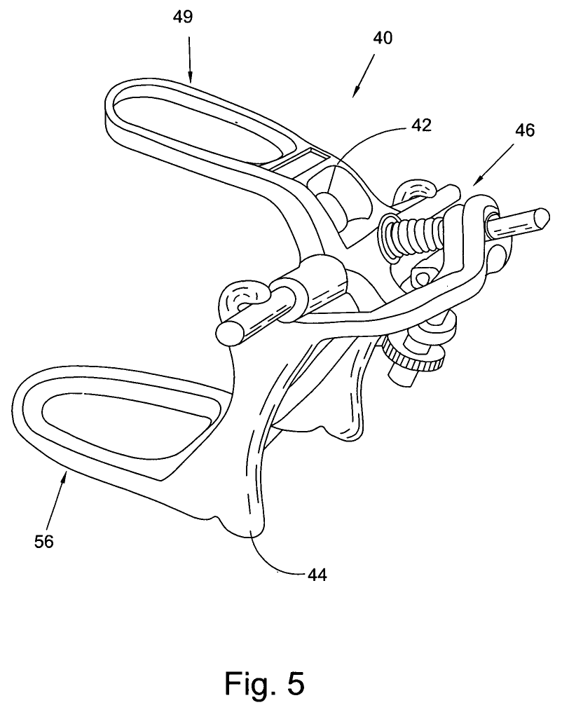

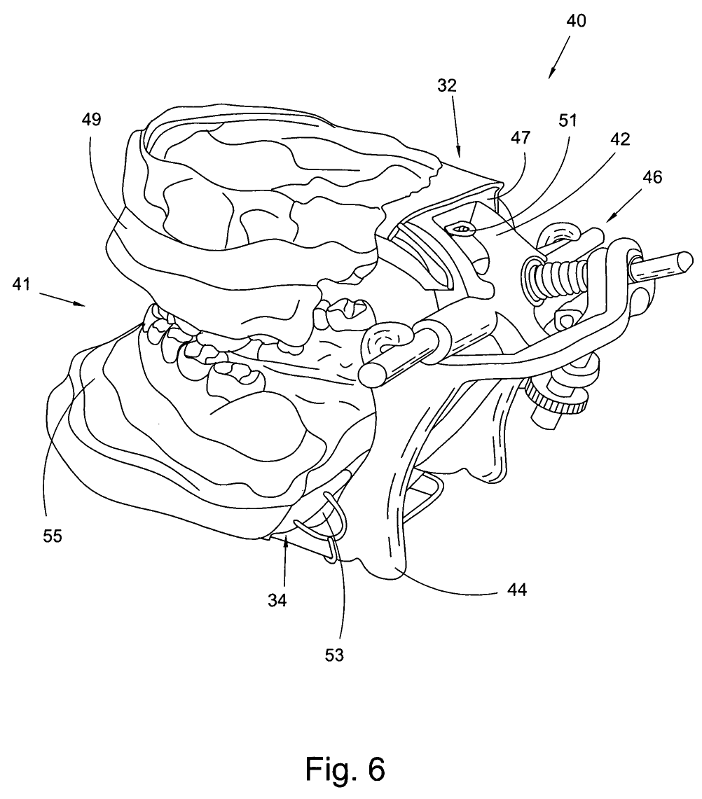

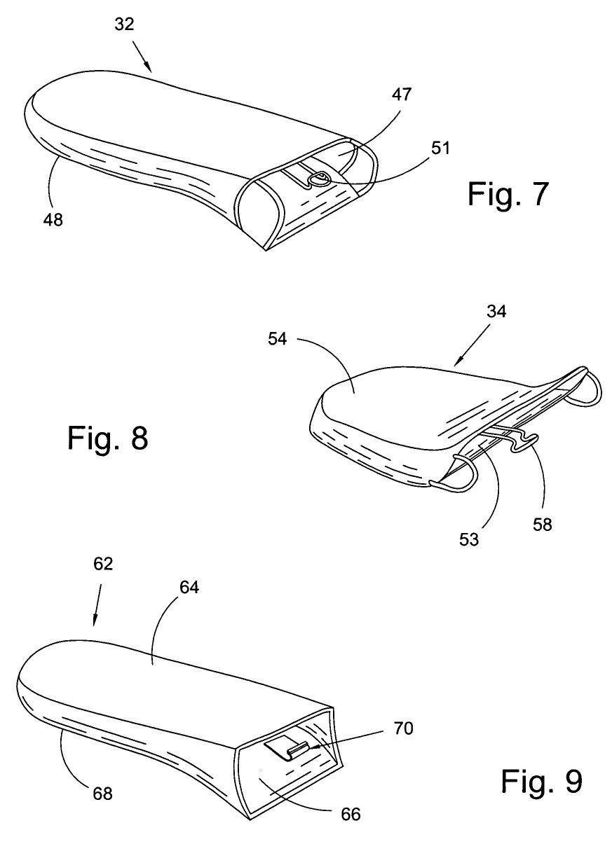

Adverting now to the figures, FIG. 3 shows a perspective view of two embodiments of present invention first and second articulator sleeves 32 and 34, respectively, releasably secured to dental articulator 40, while FIG. 4 shows a perspective view of sleeves 32 and 34 being removed from dental articulator 40, and FIG. 5 further shows a perspective view of dental articulator 40 after removal of sleeves 32 and 34. Additionally, FIG. 6 shows a perspective view of sleeves 32 and 34 releasably secured to dental articulator 40 and having dental model 41 fixedly secured thereon, and FIG. 7 shows a perspective view of first articulator sleeve 32, while FIG. 8 shows a perspective view of second articulator sleeve 34. The following discussion is best understood in view of FIGS. 3 through 8.

Dental articulator 40 includes upper and lower jaws 42 and 44, respectively. Jaws 42 and 44 are pivotally secured via hinge 46 so that dental articulator 40 may be used to represent the temporomandibular joint and jaws. In other words, dental articulator 40 may be used to simulate a human mouth. The present invention further includes first articulator sleeve 32 releasably secured to upper jaw 42 and second articulator sleeve 34 releasably secured to lower jaw 44. First articulator sleeve 32 includes opening 47 arranged to permit placement of sleeve 32 about upper jaw 42 and also includes mounting surface 48 whereon maxillary dental cast 49 may be bonded. As can be seen in the figures, first articulator sleeve 32 is arranged to substantially cover upper mount 50 of upper jaw 42. Additionally, first articulator sleeve 32 is releasably secured to upper jaw 42 via releasable locking means 51. Upon disengagement of releasable locking means 51, first articulator sleeve 32 may be removed from upper jaw 42, i.e., removed in the direction of arrow 52. Similarly, second articulator sleeve 34 includes opening 53 arranged to permit placement of sleeve 34 about lower jaw 44 and also includes mounting surface 54 whereon a mandibular dental cast 55 may be bonded. As can be seen in the figures, second articulator sleeve 34 is arranged to substantially cover lower mount 56 of lower jaw 44. Additionally, second articulator sleeve 34 is releasably secured to lower jaw 44 via releasable locking means 58. Upon disengagement of releasable locking means 58, second articulator sleeve 34 may be removed from lower jaw 44, i.e., removed in the direction of arrow 60. Thus, it can be seen in view of FIGS. 3 through 6, that maxillary and mandibular dental casts 49 and 55, respectively, may be mounted on dental articulator 40, having first and second articulator sleeves 32 and 34, respectively, intermediate casts 49 and 50 and jaws 42 and 44, respectively. The nature and structure of articulator sleeves is discussed in greater detail infra.

FIG. 9 shows a perspective view of yet another embodiment of a present invention sleeve for a dental articulator, i.e., third articulator sleeve 62. In this embodiment, sleeve 62 is molded plastic enclosure 64 having open end 66 and mounting surface 68. Additionally, similar to the aforementioned embodiments, releasable locking means 70 is included to releasably secure sleeve 62 to an articulator (not shown). Although in this embodiment, releasable locking means 70 is shown as a tab, one of ordinary skill in the art will recognize that other releasable locking means are also possible, for example, a molded plastic tab, a clip, a hook, a piece of spring steel, equivalents thereto and combinations thereof, and such variations are within the spirit and scope of the claimed invention. Additionally, a present invention articulator sleeve may be constructed without a locking means, or alternatively, the opening of the sleeve may be sized so that the sleeve has an interference fit with a jaw of an articulator. Similarly, one of ordinary skill in the art will appreciate that a present invention sleeve for a dental articulator may be constructed from a variety of materials, e.g., plastic, metal or wood, and such variations are within the spirit and scope of the claimed invention.

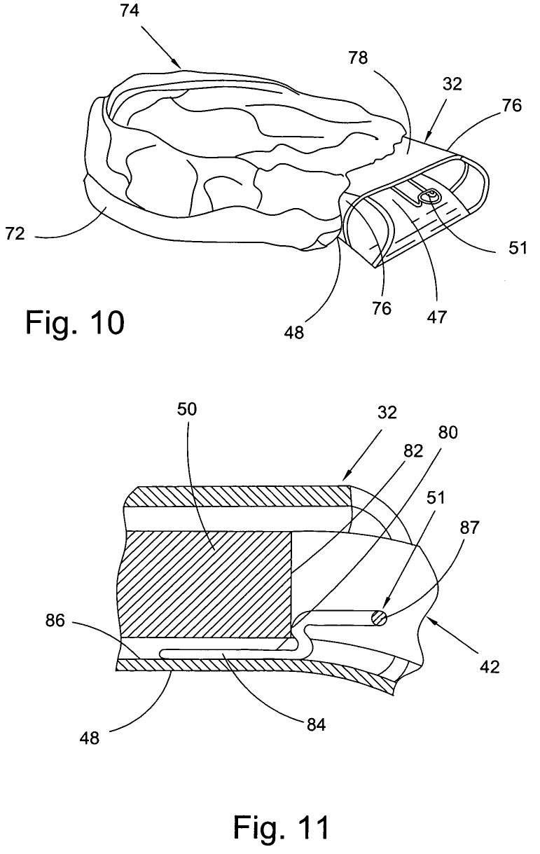

FIG. 10 shows a perspective view of an embodiment of a present invention first articulator sleeve 32 having dental model 72 fixedly secured thereto. As can be seen in the figure, although dental model 72 is fixedly secured to mounting surface 48, additional bonding material may partially or fully enclose sleeve 32. In other words, bonding material 74 may also adhere to side surfaces 76 and/or top surface 78. Hence, it should be appreciated that by utilizing a present invention articulator sleeve, e.g., first articulator sleeve 32, bonding material adheres exclusively to the sleeve and not a jaw and/or mounts of a dental articulator.

FIG. 11 shows a cross-sectional view of an embodiment of present invention articulator sleeve 32 and upper jaw 42 taken generally along line 11-11 of FIG. 3. As can be seen in this figure, releasable locking means 51 includes bent portion 80 which is operatively arranged to releasably engage locking surface 82 of upper mount 50 and further includes extended portion 84 which is fixedly secured to inner wall 86 of first articulator sleeve 32. Thus, by depressing end 87, bent portion 80 disengages from locking surface 82, thereby permitting removal of articulator sleeve 32 from upper jaw 42.

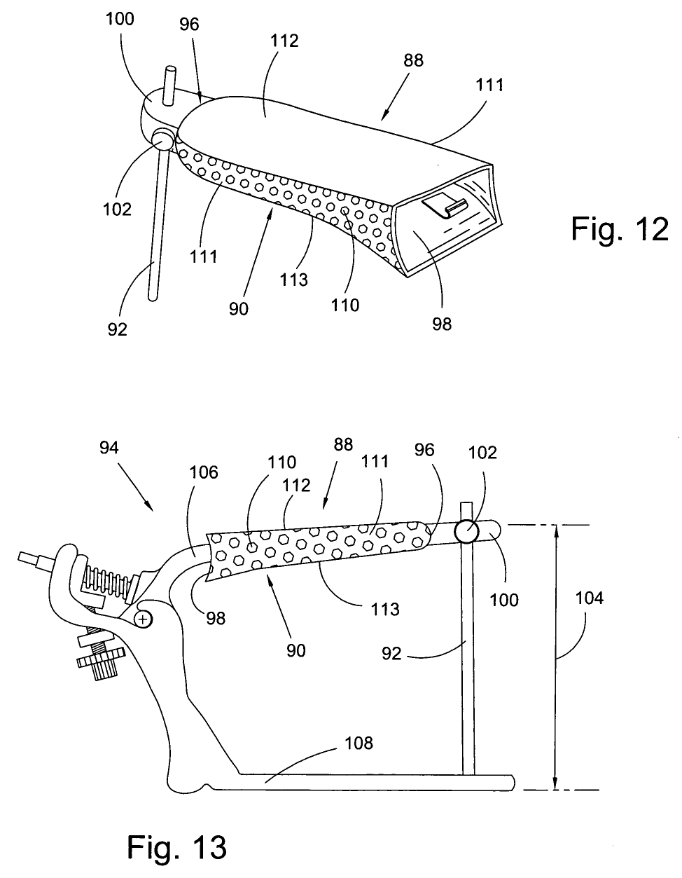

FIG. 12 shows a perspective view of a further embodiment of present invention articulator sleeve 88 having textured surface 90 and used with a dental articulator needing alignment pin 92, while FIG. 13 shows a side elevational view of the embodiment of present invention articulator sleeve 88 of FIG. 12 shown installed on dental articulator 94. As can be appreciated from the figures, articulator sleeve 88 is a longitudinal enclosure adapted for dental articulator 94. In this embodiment, sleeve 88 includes closed end 96 and open end 98 opposite closed end 96. Articulator sleeve 88 may further include releasable alignment pin retaining means 100 disposed proximate closed end 96. In some embodiments, releasable alignment pin retaining means 100 is releasably secured to closed end 96, while in other embodiments, releasable alignment pin retaining means 100 is integral to closed end 96. In the embodiments shown in these figures, releasable pin locking means 100 includes knob 102, which when rotated, releases or engages pin 92 relative to alignment pin retaining means 100. One of ordinary skill in the art will appreciate that knob 102 may interact with a variety of locking means, for example, a threaded screw or a spring loaded pin, and such variation are within the spirit and scope of the claimed invention. Hence, by adjusting the position of pin 92 relative to releasable alignment pin retaining means 100, height 104, i.e., the distance between upper and lower jaws 106 and 108, respectively, may be controlled.

In some embodiments, the present invention articulator sleeve may further include a textured surface operatively arranged to provide additional surface area for bonding a dental model thereto with an adhesive. For example, as shown in FIGS. 12 and 13, articulator sleeve 88 may include textured surface 90. In some embodiments, textured surface 90 may include a plurality of elevations 110 extending outwardly from sleeve 88. As one of ordinary skill in the art will recognize, surface area may be increased by including elevations and/or depressions, and such variations are within the spirit and scope of the claimed invention. Similarly, although textured surface 90 is shown only on side surfaces 111, it is within the spirit and scope of the claimed invention to include a textured surface on other surfaces of sleeve 88, for example, upper surface 112 or mounting surface 113.

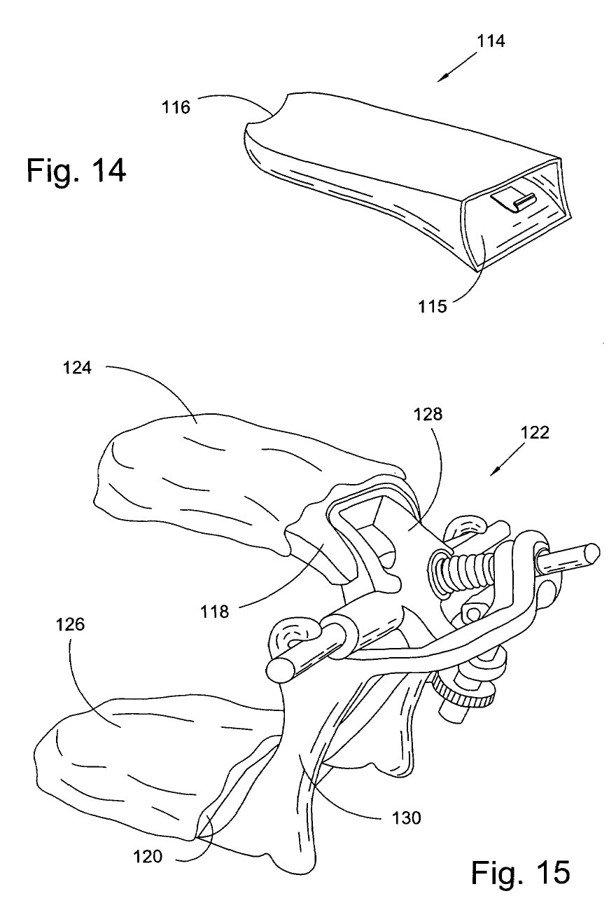

FIG. 14 shows a perspective view of another embodiment of present invention articulator sleeve 114 having first open end 115 disposed opposite second open end 116. In this embodiment, articulator sleeve 114 is a longitudinal enclosure adapted for a dental articulator having a releasable alignment pin retaining means integral to an upper or lower jaw of the articulator. Thus, by removing the pin from the articulator, sleeve 114 may pass unencumbered over the upper or upper jaw of the articulator and consequently, the alignment pin retaining means. Subsequently, the pin may be restored to its original location and utilized according to the above described method of controlling the distance between the upper and lower jaws of the dental articulator.

FIG. 15 shows a perspective view of yet another embodiment of present invention first and second articulator sleeves 118 and 120, respectively, fixedly secured to dental articulator 122 and having first and second removable sleeves 124 and 126, respectively, disposed thereon. In this embodiment, first articulator sleeve 118 is fixedly secured to upper jaw 128, while second articulator sleeve 120 is fixedly secured to lower jaw 130. As with the previously described embodiments, sleeve 118 is operatively arranged to substantially cover upper jaw 128, while sleeve 120 is operatively arranged to substantially cover lower jaw 130. Prior to adhering a dental model to articulator 122, first removable sleeve 124 is disposed about and substantially covers first articulator sleeve 118, while second removable sleeve 126 is disposed about and substantially covers second articulator sleeve 120. Subsequent to placement of first and second removable sleeves 124 and 126, respectively, a dental model may be adhered to articulator 122 as described in the above embodiments. Then, after use of the dental models is complete, the models may be removed by merely removing removable first removable sleeve 124 from first articulator sleeves 118 and second removable sleeve 126 from articulator sleeve 120. Although first and second removable sleeves 124 and 126, respectively, are depicted as flexible pouches, one of ordinary skill in the art will recognize that other forms are also possible, e.g., a molded plastic enclosure, and such variations are within the spirit and scope of the claimed invention.

As one of ordinary skill in the art appreciates, the above described apparatus permits a person to releasably secure dental models on a dental articulator. Accordingly, the user may releasably secure a first sleeve on an upper jaw and/or a second sleeve on a lower jaw of the dental articulator. Subsequently, the user may fixedly secure the dental model to the sleeve. Additionally, after the user has completed their work with the dental models, the first sleeve may be removed from the upper jaw and/or the second sleeve removed from the lower jaw. Thus, according to the aforementioned method, a user may repeatedly use the same dental articulator for a plurality of dental models, without risk of damaging the articulator during removal of the dental models.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A sleeve for a dental articulator having upper and lower jaws operatively arranged to simulate a human mouth, said sleeve comprising:
an enclosure comprising a mounting surface and at least one open end, said enclosure arranged to substantially cover and releasably engage said upper or lower jaw of said dental articulator.

2. The sleeve for a dental articulator of claim 1 further comprising a releasable locking means operatively arranged to releasably secure said sleeve to said upper or lower jaw of said dental articulator.

3. The sleeve for a dental articulator of claim 2 wherein said releasable locking means is a tab.

4. The sleeve for a dental articulator of claim 2 wherein said releasable locking means is a clip.

5. The sleeve for a dental articulator of claim 2 wherein said releasable locking means is a hook.

6. The sleeve for a dental articulator of claim 1 wherein said enclosure further comprises a textured surface.

7. The sleeve for a dental articulator of claim 6 wherein said textured surface is operatively arranged to provide additional surface area for bonding a dental model thereto with an adhesive.

8. The sleeve for a dental articulator of claim 6 wherein said textured surface comprises a plurality of elevations extending outwardly from said enclosure.

9. The sleeve for a dental articulator of claim 1, wherein said enclosure is a longitudinal enclosure adapted for said dental articulator having a closed first end and an open second end opposite said closed first end.

10. The sleeve for a dental articulator of claim 9 further comprising an alignment pin retaining means disposed proximate said closed first end.

11. The sleeve for a dental articulator of claim 10 wherein said alignment pin retaining means is integral to said closed first end.

12. The sleeve for a dental articulator of claim 10 wherein said alignment pin retaining means is releasably secured to said closed first end.

13. The sleeve for a dental articulator of claim 1, wherein said enclosure is a longitudinal enclosure adapted for said dental articulator having an open first end and an open second end opposite said open first end.

14. The sleeve for a dental articulator of claim 1, wherein said enclosure is constructed from a material selected from the group consisting of wood, metal, plastic, ceramic and combinations thereof.

15. A dental articulator comprising:
upper and lower jaws arranged to simulate a human mouth; and,
a sleeve comprising a mounting surface and at least one open end, said sleeve arranged to substantially cover and releasably engage said upper or lower jaw of said dental articulator.

16. A dental articulator comprising:
upper and lower jaws arranged to simulate a human mouth; and,
a first sleeve comprising a mounting surface and at least one open end, said first sleeve arranged to substantially cover and fixedly secure to said upper or lower jaw of said dental articulator.

17. The dental articulator of claim 16 further comprising a second sleeve operatively arranged to substantially cover and releasably engage said first sleeve.

18. A method of mounting a dental model on a dental articulator having upper and lower jaws arranged to simulate a human mouth, said method comprising the steps of:
(a) releasably securing a sleeve on said upper or lower jaw of said dental articulator; and,
(b) fixedly securing said dental model to said sleeve.

19. The method of mounting a dental model on a dental articulator of claim 18 further comprising the step of:
(c) removing said sleeve from said upper or lower jaw of said dental articulator.

20. The method of mounting a dental model on a dental articulator of claim 18 wherein said sleeve comprises a mounting surface and at least one open end, said sleeve arranged to substantially cover and releasably engage said upper or lower jaw of said dental articulator.
